(19) United States
(12) Patent Application Publication
(10) Pub. No.: US 2024/0364460 A1
(43) Pub. Date: Oct. 31, 2024

(54) SYSTEMS, METHODS, AND NON-TRANSITORY PROCESSOR-READABLE MEDIA FOR INDICATING REPETITION INFORMATION FOR RETRANSMISSIONS

(71) Applicant: ZTE Corporation, Shenzhen (CN)

(72) Inventors: Xing LIU, Shenzhen (CN); Junfeng ZHANG, Shenzhen (CN); Xianghui HAN, Shenzhen (CN); Shuaihua KOU, Shenzhen (CN); Min REN, Shenzhen (CN)

(73) Assignee: ZTE Corporation, Shenzhen (CN)

(21) Appl. No.: 18/766,843

(22) Filed: Jul. 9, 2024

Related U.S. Application Data
(63) Continuation of application No. PCT/CN2022/109791, filed on Aug. 2, 2022.

(51) Int. Cl. H04L 1/08; H04W 74/0833

(52) U.S. Cl. CPC H04L 1/08; H04W 74/0833

(57) ABSTRACT

Systems, methods, non-transitory processor-readable media, and apparatuses for determining, by a wireless communication device, a time-domain resource and a frequency-domain resource for transmitting at least one repetition of a Physical Random Access Channel (PRACH). The wireless communication device transmits to a base station, the at least one repetition of the PRACH using the time-domain resource and the frequency-domain resource.

### CROSS-REFERENCE TO RELATED APPLICATION

This application claims the benefit of priority under 35 U.S.C. § 120 as a continuation of International Patent Application No. PCT/CN2022/109791, filed on Aug. 2, 2022, the disclosure of which is incorporated herein by reference in its entirety.

### TECHNICAL FIELD

The disclosure relates generally to wireless communications and, more particularly, to systems, methods, and non-transitory processor-readable media for indicating repetition information for transmissions.

### BACKGROUND

Currently, the first phase standardization of the 5th Generation Mobile Communication Technology (5G) has already completed. A series features have been specified in the first three New Radio (NR) releases, i.e. Rel-15, Rel-16, and Rel-17. Coverage is one of the key factors in implementing cellular communication networks due to its direct impact on service quality as well as capital expenditure (CAPEX) and operational expenditure (OPEX). Despite the importance of coverage on the success of NR implementation, a thorough coverage evaluation and a comparison with legacy Radio Access Technologies (RATs) considering all NR specification details have not been performed until now.

### SUMMARY

In some arrangements, systems, methods, apparatuses, and non-transitory computer-readable media for determining, by a User Equipment (UE), a time-domain resource and a frequency-domain resource for transmitting at least one repetition of a Physical Random Access Channel (PRACH). The UE transmits to a base station, the at least one repetition of the PRACH using the time-domain resource and the frequency-domain resource.

In some arrangements, systems, methods, apparatuses, and non-transitory computer-readable media for configuring, by a base station for a UE, a time-domain resource and a frequency-domain resource for transmitting at least one repetition of a PRACH. The base station receives from the UE, the at least one repetition of the PRACH using the time-domain resource and the frequency-domain resource.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is a diagram illustrating an example cellular communication network, in accordance with some arrangements.

FIG. 2 illustrates block diagrams of an example base station and an example user equipment device, in accordance with some arrangements.

FIG. 3 illustrates an example scheme implemented for supporting the initial access.

FIG. 4 is a table of PRACH configuration index mapped to random access configurations, in accordance with some arrangements.

FIG. 5 shows an example of a structure of the Radio Resource Control (RRC) signaling, in accordance with some arrangements.

FIG. 6 is a table illustrating the relationship between repetition numbers and time-domain window indexes, according to some arrangements.

FIG. 7 illustrates resources for transmitting uplink data (e.g., PRACH-related data), according to some arrangements.

FIG. 8 illustrates resources for transmitting uplink data (e.g., PRACH-related data), according to some arrangements.

FIG. 9 illustrates resources for transmitting uplink data (e.g., PRACH-related data), according to some arrangements.

FIG. 10 illustrates resources for transmitting uplink data (e.g., PRACH-related data), according to some arrangements.

FIG. 11 illustrates resources for transmitting uplink data (e.g., PRACH-related data), according to some arrangements.

FIG. 12 illustrates resources for transmitting uplink data (e.g., PRACH-related data), according to some arrangements.

FIG. 13 illustrates resources for transmitting uplink data (e.g., PRACH-related data), according to some arrangements.

FIG. 14 illustrates resources for transmitting uplink data (e.g., PRACH-related data), according to some arrangements.

FIGS. 15, 16, and 17 illustrate tables for associating RO resources with SSBs using an RO window combination, according to some arrangements.

FIG. 18 illustrates resources for transmitting uplink data (e.g., PRACH-related data), according to some arrangements.

FIG. 19 illustrates resources for transmitting uplink data (e.g., PRACH-related data), according to some arrangements.

FIG. 20 illustrates resources for transmitting uplink data (e.g., PRACH-related data), according to some arrangements.

FIG. 21 illustrates resources for transmitting uplink data (e.g., PRACH-related data), according to some arrangements.

FIG. 22 illustrates resources for transmitting uplink data (e.g., PRACH-related data), according to some arrangements.

FIG. 23 illustrates resources for transmitting uplink data (e.g., PRACH-related data), according to some arrangements.

FIG. 24 is a flowchart diagram illustrating an example method for transmitting at least one repetition of PRACH, according to some arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

Among physical channels used during initial access procedures and handover procedures, Physical Random Access Channel (PRACH) which requests uplink allocation for sending uplink data to the base station is a potential coverage bottleneck. The arrangements disclosed herein relate to improving the coverage of PRACH, and in particular, to the repetition transmissions of PRACH. The PRACH resource for different repetition numbers can be indicated according to various arrangements.

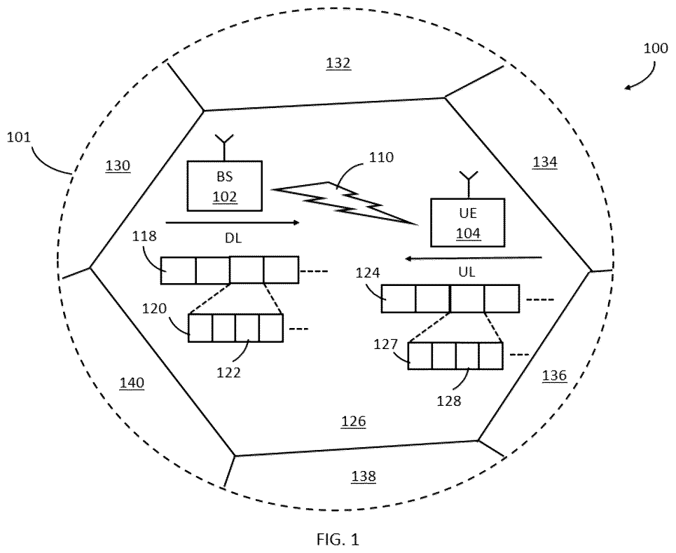

FIG. 1 illustrates an example wireless communication system 100, in accordance with an arrangement of the present disclosure. In the following discussion, the wireless communication system 100 may be any wireless network, such as a cellular network or a narrowband network. The system 100 includes a base station 102 and a UE 104 that can communicate with each other via a communication link 110 (e.g., a wireless communication channel), and a cluster of cells, e.g., at least 126, 130, 132, 134, 136, 138 and 140 overlaying a geographical area 101. In FIG. 1, the base station 102 and UE 104 are shown to be located within a respective geographic boundary of cell 126. Each of the other cells 130, 132, 134, 136, 138 and 140 may include at least one base station operating at its allocated bandwidth to provide adequate radio coverage to its intended users.

For example, the base station 102 may operate at an allocated channel transmission bandwidth to provide adequate coverage to the UE 104. The base station 102 and the UE 104 may communicate via a downlink radio frame 118, and an uplink radio frame 124 respectively. Each radio frame 118/124 may be further divided into subframes (or slots) 120/127 which may include data symbols 122/128. In the present disclosure, the base station 102 and UE 104 are described herein as non-limiting examples of communication nodes, generally, which can practice the methods disclosed herein. Such communication nodes may be capable of wireless and/or wired communications, in accordance with various arrangements of the present solution.

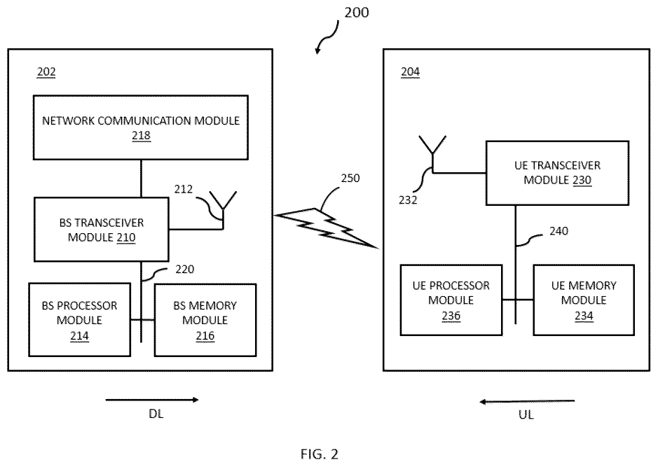

FIG. 2 illustrates a block diagram of an example wireless communication system 200 for transmitting and receiving wireless communication signals, in accordance with some arrangements. The system 200 may include components and elements configured to support known or conventional operating features that need not be described in detail herein. In some arrangements, system 200 can be used to communicate (e.g., transmit and receive) data symbols in a wireless communication environment such as the wireless communication system 100 of FIG. 1, as described above.

The system 200 generally includes a base station 202 and a UE 204. The base station 202 includes a base station transceiver module 210, a base station antenna 212, a base station processor module 214, a base station memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The base station 202 communicates with the UE 204 via a communication channel 250, which can be any wireless channel or other medium suitable for transmission of data as described herein.

The system 200 may further include any number of modules other than the modules shown in FIG. 2. The various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some arrangements, the UE transceiver 230 may be referred to herein as an uplink transceiver 230 that includes a Radio Frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the base station transceiver 210 may be referred to herein as a downlink transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the base station 202 may be an gNB, evolved node B (eNB), a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

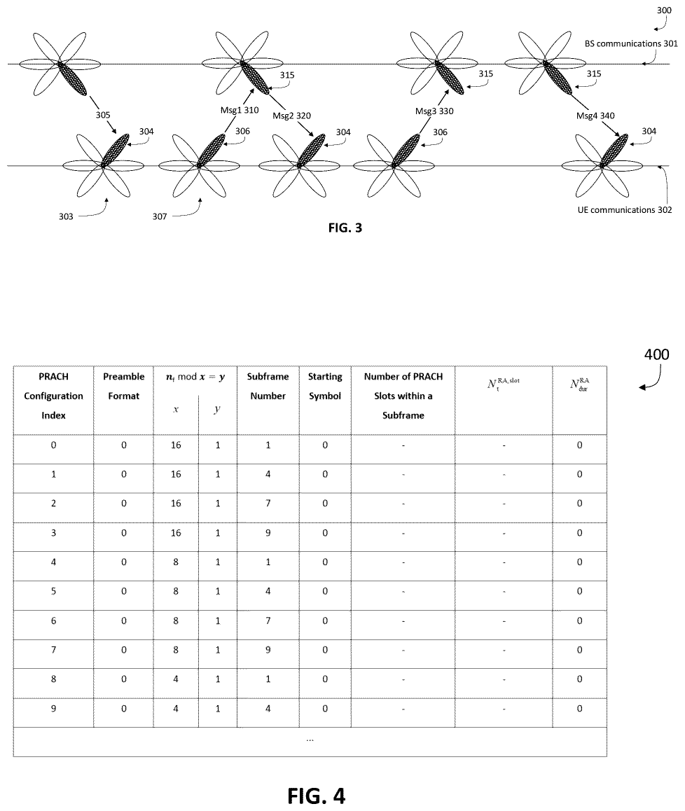

In some examples, FIG. 3 illustrates an example scheme 300 implemented for supporting the initial access (e.g., PRACH procedure) under frequency ranges FR1 (e.g., sub-6G Hz band) and frequency range FR2 (e.g., beyond 6G Hz band). In FIG. 3, the base station communications 301 (e.g., beamforming) of a base station (e.g., the base station 102, 202) can be shown on the top rail while UE communications 302 (e.g., beamforming) of a UE (e.g., the UE 104, 204) can be shown on the bottom rail. The transmission of PRACH for example can be transmitted via Msg1 310. The scheme 300 further includes different PRACH formats, PRACH resource configurations, the relationship between the Synchronization Signal/Physical Broadcasting Channel (PBCH) Block (SSB) and PRACH occasion, the mechanism of PRACH retransmission, the mechanism of PRACH power control, and so on.

The shaded beams in FIG. 3 are beams used to transmit or receive data. As shown in FIG. 3, the UE transmits a preamble in PRACH Occasion (RO), according to the configuration of PRACH transmission and a selected SSB. In transmitting the preamble in RO, if the transmit-receive correspondence on the UE-side can be guaranteed, a fixed mapping between the UE's receiving (Rx) beam and the UE's transmitting (Tx) beam can be used. A unique Tx beam can be determined according to its receiving of the SSB. Specifically, the UE may attempt to use different Rx beams 303 to receive the SSB from the base station (e.g., at 305), and determine the best Rx beam 304. In some arrangements, the best Rx beam 304 (e.g., the best downlink Rx beam) is a beam with the highest RSRP. According to the best Rx beam 304, the best Tx beam 306 (e.g., best uplink Tx beam) is determined based on beam correspondence. The RO used for transmitting the PRACH will be determined according to the relationship between the SSB and PRACH occasion. Basing on the relationship, the base station can determine the SSB selected by the UE. The same beam 315 can be used for transmitting subsequent downlink transmissions, including, Msg2 320 (which can also be referred to as Random Access Response (RAR) and Msg4 340. According to the legacy RACH procedure, the RAR (e.g., Msg2 320) is communicated after the end of PRACH transmission (e.g., Msg1 310). The RAR window starts at the first symbol of the earliest Control Resource Set (CORESET) for which the UE is configured to receive Physical Downlink Control Channel (PDCCH) for Type1-PDCCH Common Search Space (CSS) set, that is at least a predefined number of time units (e.g., symbols) after the last symbol of the PRACH occasion corresponding to the PRACH transmission.

On the other hand, if the Tx-Rx correspondence of UE side cannot be guaranteed, the UE needs to try different Tx beams 307 for transmitting the PRACH (e.g., Msg 1 310). This case is very likely when the UE is using mm-Wave band. According to the current initial access procedure, the UE can only determine a suitable transmission beam by attempting RACH retransmission with various Tx beams 307 after failing the previous RACH transmission, which is inefficient.

Thus, allowing multiple transmission of PRACH before the start or end of the RAR window can effectively improve the coverage and efficiency. More specifically, multiple PRACH transmissions (which can also be referred to as PRACH repetition) with same beam can be used for combination reception at the base station, which is useful for improving the receiving performance. PRACH repetition with different beams can be used for identifying the best UE Tx beam, and further use the best UE Tx beam for the subsequent uplink transmission (e.g., Msg3 330). This improves the performance of the access procedure. Some arrangements disclosed herein relate to distinguishing RACH resources for RACH transmission with different number of repetitions.

In some arrangements, the base station configures the time-domain resource of RACH transmission for the UE via RRC signaling or PDCCH, for example, such as the parameter PRACH configuration index (or prach-ConfigurationIndex). The PRACH configuration index is an index that maps to a row in a table of random access configurations, a partial example 400 of which is illustrated in FIG. 4. In some examples, the entire table for random access configurations may have 256 rows, with the values PRACH configuration index within a range of 0-255 for indicating 256 different random access configurations. The random access configurations include for example, preamble format, nᵢ mod x=y, subframe number, starting symbol, number of PRACH slots within a subframe, Nₜ^{RA,slot}, and N_{dur}^{RA,}. The UE transmits the RACH transmission using a time-domain resource defined by the random access configurations. The table 400 indicates the preamble format to be used for each PRACH configuration index. In some examples, for each

PRACH configuration index, x and y for nᵢ mod x=y are provided. In some examples, nᵢ represents the System Frame Number (SFN) where the RACH transmission (e.g., preamble) resource is located, x represents the period, and y represents offset. That is, nᵢ is the set of SFNs, which meets the period as x and offset as y. Furthermore, for each PRACH configuration index, time-domain resource for transmitting the preamble is identified by parameters such as SFN, the subframe number, starting symbol, a number of PRACH slots within a subframe, Nₜ^{RA,slot}, and N_{dur}^{RA,} is provided. In some examples, Nₜ^{RA,slot} is the number of time-domain PRACH occasions within a PRACH slot. In some examples, N_{dur}^{RA,} is the PRACH duration.

In some examples, the base station configures the frequency-domain resource of RACH transmission for the UE via RRC signaling. An example of the structure of the RRC signaling 500 is shown in FIG. 5. RRC signaling parameter msg1-FrequencyStart provides a frequency starting Resource Block (RB) within a carrier, which is defined by an integer from 0 to a maximum number. In addition, the RRC signaling parameter msg1-FDM further provides a number of RACH transmission resources that are Frequency Domain Multiplexed (FDMed). In some arrangements, the base station configures a time-frequency resource, which includes a time-domain resource and a frequency-domain resource. The time-frequency resource are illustrated in some of the FIGS. herein with the vertical dimension corresponding to frequency and the horizontal dimension corresponding to time.

In some arrangements, different time-domain windows for PRACH transmission with different repetition numbers are defined. The UE can determine the different time-domain windows for repetitions of the PRACH transmission.

In some arrangements, time-domain windows for different PRACH transmission with different repetition numbers do not overlap with each other in the time domain. In some arrangements, different time-domain windows are consecutively connected to each other according to an order or sequence in the time domain. In some examples, the order is predefined. In some arrangements, the time-domain windows are sorted in ascending order of numbers of repetition, with time-domain windows with fewer number of repetitions placed in the order before the time-domain windows with a greater number of repetitions.

Thus, in some examples, the plurality of time-domain windows are arranged according to an order, or the plurality of time-domain windows are cyclical. The order in which the plurality of time-domain windows are arranged comprises an ascending order of the numbers of repetitions of each of the plurality of PRACH transmissions. In some examples, the plurality of time-domain windows are consecutively connected to one another.

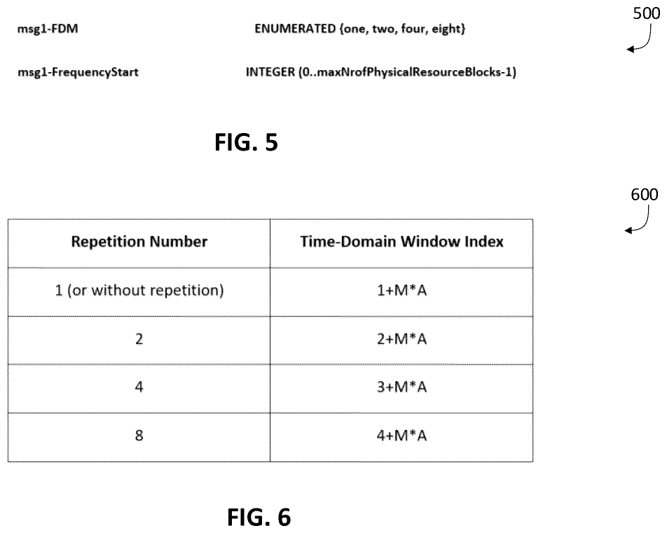

For example, a number M (e.g., 4) of different repetition numbers N are supported in one cell, including N=1, 2, 4, 8. The time-domain windows for PRACH transmission with different repetition times N are arranged cyclically. FIG. 6 is a table 600 illustrating the relationship between repetition numbers and time-domain window indices, according to some arrangements. The time-domain window index identifies a corresponding time-domain window, which corresponds to a different repetition number. In some examples, the time-domain window indices may be arranged to correspond to an order of repetition numbers (e.g., N=1, 2, 4, 8). For example, time-domain window index 1 corresponds to N=1, time-domain window index 2 corresponds to N=2, time-domain window index 3 corresponds to N=4, time-domain window index 4 corresponds to N=8, time-domain window index 5 corresponds to N=1, and so on. The parameter A is non-negative integer, e.g., A=0, 1, 2, 3, 4, . . . , etc. M (e.g., 4) is the number of different repetition numbers. The first time-domain window has a time-domain window index of 1 and is for PRACH transmission with repetition number N=1, which represents that PRACH transmission is without repetition. The second time-domain window has a time-domain window index of 6 and is for PRACH transmission with repetition number N=2. The third time-domain window has a time-domain window index of 11 and is for PRACH transmission with repetition number N=4. The fourth time-domain window has a time-domain window index of 16 and is for PRACH transmission with repetition number N=8. The first, second, third, and fourth time-domain windows are directly connected to one another in that order. The fifth time-domain window is for PRACH transmission with N=1 due to the cyclical nature, and so on.

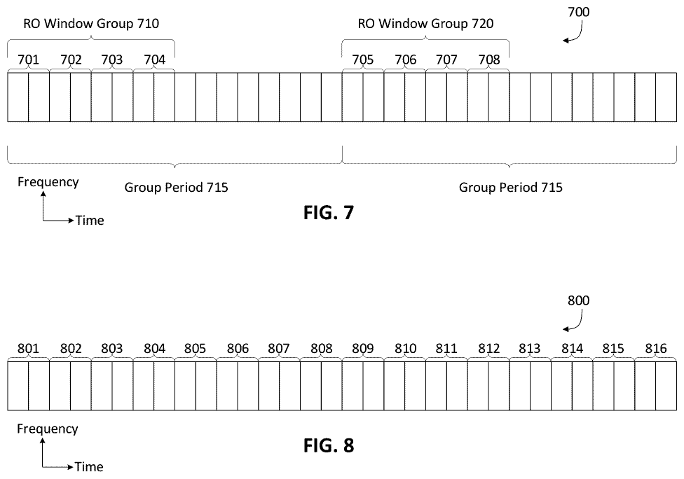

The time-domain window for PRACH transmission can be referred to as RO window, RO bundle, or RO group. In some arrangements, a RO window group or time-domain window group can be defined as a time-domain resource containing two or more RO windows. An RO window group contains one RO window for each repetition number in some examples. As shown in FIG. 7 which illustrates resources 700 that the UE can use to transmit uplink data (e.g., PRACH-related data) according to some arrangements, there are two RO window groups 710 and 720. The horizontal dimension corresponds to time, and the vertical dimension corresponds to frequency. Each block in FIG. 7 is one of the resources 700, which along the horizontal dimension corresponds to a frame, subframe, slot, RACH occasion, or millisecond, etc. Each RO window includes one or more (e.g., two) time-domain resources for preamble transmitting. The first RO window group 710 contains RO windows 701, 702, 703 and 704. The second RO window group 720 contains RO windows 705, 706, 707 and 708. In some arrangements, a group period (e.g., group period 715) of the RO window groups can be configured by the base station for the UE. The RO window groups occur periodically (e.g., every group period 715). Then, adjacent RO window groups may be discontinuous (e.g., with a gap of at least one time-domain resource between two adjacent RO window groups), and the group periods may be continuous. In other words, in some examples, the plurality of time-domain windows comprises at least one time-domain window group, the at least one time-domain window group appears periodically, and adjacent time-domain window groups are discontinuous. In other examples, the plurality of time-domain windows comprises at least two sets of time-domain window group, the time-domain window groups in a same set appear periodically, different time-domain window group sets are configured with different periods.

FIG. 8 illustrates resources 800 that the UE can use to transmit uplink data (e.g., PRACH-related data) according to some arrangements. The horizontal dimension corresponds to time, and the vertical dimension corresponds to frequency. Each block in FIG. 8 is one of the resources 800, which along the horizontal dimension corresponds to a frame, subframe, slot, RACH occasion, or millisecond. Each RO window includes one or more (e.g., two) time-domain resources. As shown in FIG. 8, the RO windows 801-816 are associated with different repetition numbers in a cyclical manner as described. For example, different RO windows are consecutively connected with no gap therebetween. As shown, the ending point of a RO window is the starting point of the next RO window. In some arrangements, different RO windows can also be discontinuous.

In some arrangements, the length of RO windows that correspond to different number of repetitions is the same. In other arrangements, the length of RO windows corresponding to different number of repetitions are different. That is, in some examples, the UE determines a length for each of the plurality of time-domain windows. Lengths of two or more of the plurality of time-domain windows are same or different. For example, the base station can configure a reference length of RO window (L_{R}) for the UE (via RRC signaling) from a value set, e.g., 5 ms, 10 ms, 20 ms, 40 ms, 80 ms, 160 ms, etc. Further, the base station can configure at least one scaling factor (α) for the UE via RRC signaling from a value set, e.g., ¼, ½, 1, 2, 4, etc. This parameter is used to flexibly control the length ratio of RO window of different repetition number. The UE determines the length for each of the plurality of time-domain windows by receiving, from the base station, one or more reference length and at least one scaling factor, and determining the length for each of the plurality of time-domain windows based on one or more of the reference length, the at least one scaling factor, and the different number of repetitions.

For example, the actual length of RO window (L_{A}) for different repetition numbers can be determined by the UE according to the repetition number (N), the scaling factor (α), and the reference length of RO window (L_{R}). In some examples, the following expression can be used:

$${L}_{A} = {L}_{R} \times {α}^{{log}_{2}^{N} - 1} . \qquad ( 1 )$$

In some examples in which the scaling factor is absent, or α=1, the actual length of RO window (L_{A}) for different repetition number is the same as and equals to L_{R}.

In some examples in which the scaling factor α is larger than one, the larger the number of repetitions, the longer the actual length of a corresponding RO window. In the example in which α=2, for N=1, L_{A}=L_{R}; for N=2, L_{A}=2L_{R}; for N=4, L_{A}=4L_{R}; for N=8, L_{A}=8L_{R}. This mechanism facilitates maintaining the same RACH resource capacity with different number of repetitions.

In some examples in which the scaling factor a is smaller than one, the larger the number of repetitions, the shorter the actual length of RO window. In the example in which α=1/2, for N=1, L_{A}=L_{R}; for N=2, L_{A}=L_{R}/2; for N=4, L_{A}=L_{R}/4; for N=8, L_{A}=L_{R}/8. This mechanism improves efficiency of RACH resource utilization.

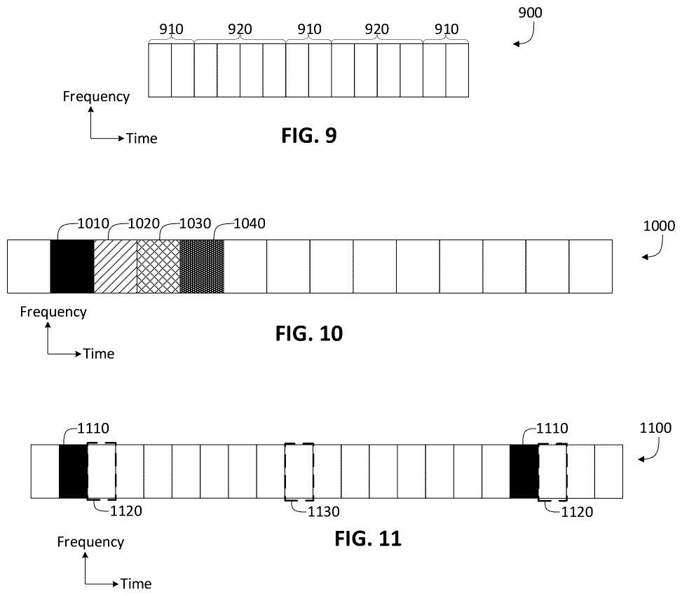

In some examples, two repetition numbers are supported in a cell, N=1 and N=2. The reference length of RO window is L_{R}=20 ms or 2 radio frames. The scaling factor is determined to be α=2. Then, the actual length of RO window is determined using expression (1). For N=1, L_{A}=L_{R}=20 ms; for N=2, L_{A}=2L_{R}=40 ms. FIG. 9 illustrates resources 900 that the UE can use to transmit uplink data (e.g., PRACH-related data) according to some arrangements. The horizontal dimension corresponds to time, and the vertical dimension corresponds to frequency. Each block in FIG. 9 is one of the resources 900, which along the horizontal dimension corresponds to a frame, subframe, slot, RACH occasion, or millisecond (ms), etc. In the example shown in FIG. 9, each time-domain resource has a length of 10 ms. Each RO window 910 includes 2 time-domain resources. Each RO window 920 includes 4 time-domain resources. As shown in FIG. 9, the RO windows 910 and 920 are associated with different repetition numbers in a cyclical manner as described. The RO windows 910 and 920 are determined according to expression (1) as noted above, using the scaling factor. For RO window 910, N=1, the length of the RO window 910 is determined as 20 ms or 2 time-domain resources (e.g., L_{A}=L_{R}=20 ms). For RO window 920, N=2, the length of the RO window 920 is determined as 40 ms or 4 time-domain resources (e.g., L_{A}=2L_{R}=40 ms).

In some arrangements, different RO windows can be discontinuous. In some arrangements, some of the RO windows are continuous and some other RO windows are discontinuous. For example, RO window 910 and 920 are continuous, but RO window 920 and the next RO window 910 are discontinuous.

In some arrangements, a same RACH configuration including at least one of prach-ConfigurationIndex, msg1-FDM, msg1-FrequencyStart, ra-ResponseWindow (e.g., a time-domain window for monitoring a PDCCH of Random access response), totalNumberOfRA-Preambles (e.g., a total number of preambles used for contention based and contention free random access), and ssb-perRACH-OccasionAndCB-PreamblesPerSSB (e.g., the number of SSBs per RACH occasion and the number of Contention Based preambles per SSB, etc.) is used for different RO windows for PRACH transmission with same repetition number.

In some arrangements, different RACH configurations including two or more of prach-ConfigurationIndex, msg1-FDM, msg1-FrequencyStart, ra-ResponseWindow, totalNumberOfRA-Preambles and ssb-perRACH-OccasionAndCB-PreamblesPerSSB, etc.) are used for different RO windows for PRACH transmission with different repetition numbers.

In some examples, each of a plurality of time-domain windows correspond to one of a plurality of PRACH transmissions. Each of the plurality of PRACH transmissions has a different number of repetitions. Accordingly, the time-domain window for PRACH transmission with different repetition number can be defined and implemented efficiently. The network can effectively distinguish RACH transmission with different number of repetitions to avoid confusion and improve PRACH receiving performance.

In some arrangements, different time-domain windows for PRACH transmission with different repetition numbers are defined. The UE can determine the different time-domain windows for repetitions of the PRACH transmission based on an offset relative to a reference PRACH transmission resource or reference time-domain resource.

In some arrangements, a PRACH configuration, e.g., PRACH configuration index (prach-ConfigurationIndex) as shown in FIG. 4 can be shared by PRACH transmissions with different repetition numbers. The PRACH transmission resource for repetition number=1 (or PRACH transmission without repetition) can determined according to the second line of the table 400. The PRACH transmission resource for repetition number=1 is the reference time-domain resource. The resource of PRACH transmission having other repetition numbers can be determined by adding an offset relative to the reference time-domain resource determined using on the table. In some examples, the UE determining the plurality of time-domain windows by determining a reference time-domain window (e.g., corresponding to no repetition) and determining at least one time-domain window (e.g., corresponding to at least one repetition or two transmissions) based on the reference time-domain window and an offset.

FIG. 10 illustrates resources 1000 that the UE can use to transmit uplink data (e.g., PRACH-related data) according to some arrangements. The horizontal dimension corresponds to time, and the vertical dimension corresponds to frequency. Each block in FIG. 10 is one of the resources 1000, which along the horizontal dimension corresponds to a frame. In the example shown in FIG. 10, a PRACH configuration (e.g., having prach-ConfigurationIndex=0) is configured for PRACH transmission with different repetition numbers. The offset can be determined based on a radio-frame level offset step size denoted as O (e.g., O=1 frame), which is configured by the base station for the UE. An offset of the RO window for PRACH transmission with repetition number greater than 1 can be determined according to the offset step size O. For example, expression (2) can be used to determine the offset based on an index i of the RO window:

$$offset = O * ( i - 1 ) , \qquad ( 2 )$$

where, i represents the index of the RO window, i.e., the i^{st} RO window. Thus, in some examples, the reference time-domain window corresponds no repetition of the PRACH or repetition number equals to 1. Each of the at least one time-domain window corresponds to at least one repetition of the PRACH. The offset is determined based on a step size and a repetition number of the at least one repetition.

Different repetition numbers may share the same RACH configuration, and offset is used to distribute time-domain resources for PRACH transmissions for different repetition numbers over time. Different repetition numbers have different time-domain resources or different RO windows. Therefore, the offset step size in combination with the repetition number can be used to define the offset for the RO window corresponding to a given repetition number.

According the PRACH configuration, at least one radio frame which satisfies:

$$SFN mod 16 = 1 , \qquad ( 3 )$$

which includes SFN=1, 17, 33, . . . , and so on, is determined as a radio frame for PRACH transmission with repetition number=1 (e.g., no repetition). In the example shown in expression (3), 16 refers to a number of frames in a period. Such at least one radio frame can be considered as the first RO windows. Second RO windows (e.g., i=2) can be determined as the radio frames which satisfy the condition:

$$SFN mod 16 = 1 + O * ( i - 1 ) = 2 , \qquad ( 4 )$$

which include SFN=2, 18, 34, . . . , and so on. Third RO windows (e.g., i=3) can be determined as the radio frames which satisfy the condition:

$$SFN mod 16 = 1 + O * ( i - 1 ) = 3 , \qquad ( 5 )$$

which include SFN=3, 19, 35, . . . , and so on. Fourth RO windows (e.g., i=4) can be determined as the radio frames which satisfy the condition:

$$SFN mod 16 = 1 + O * ( i - 1 ) = 4 , \qquad ( 6 )$$

which include SFN=4, 20, 36, . . . , and so on. RO windows map to PRACH transmissions with different repetition numbers according to a order, such as an ascending order. For example, the second RO windows are used for PRACH transmission with repetition number=2, the third RO windows are used for PRACH transmission with repetition number=4, and the fourth RO windows are used for PRACH transmission with repetition number=8.

In FIG. 10, the RO window 1010 with SFN 1 is a first RO window and spans a frame in length. With the step size of 1 frame, RO window 1020 with SFN 2 is a second RO window and spans a frame in length, has a repetition number N=2. RO window 1030 with SFN 3 is a third RO window, spanning a frame in length and having a repetition number N=4. RO window 1040 with SFN 4 is a fourth RO window, spanning a frame in length having a repetition number N=8.

In some arrangements, the lengths of RO windows for PRACH transmissions with different repetition numbers can be different. In some examples, the offset relative to the first RO window is determined based on the length of RO window. Accordingly, different RO windows would not overlap with each other. For example, the starting SFN for the i^{th} RO window can be determined according to the starting SFN of the first RO window and total length of the first (i−1) RO window. For example,

$${N}_{i}^{SFN} = {N}_{1}^{SFN} + {\sum }_{n = 1}^{i - 1} {L}_{n} ,$$

where, Nᵢ^{SFN} is the starting SFN for the i^{th} RO window, and Lₙ is the length of the n^{th} RO window. Alternatively, the starting SFN for the i^{th} RO window can be determined according to the starting SFN of the (i−1)^{th} RO window and length of the (i−1)^{th} RO window. For example, Nᵢ^{SFN}=Nᵢ₋₁^{SFN}+Lᵢ₋₁, where, Nᵢ^{SFN} is the starting SFN for the i^{th} RO window, Nᵢ₋₁^{SFN} is the starting SFN for the (i−1)^{th} RO window, and Lᵢ₋₁ is the length of the (i−1)^{th} RO window.

In some arrangements, the base station configures for the UE different PRACH configurations for PRACH transmissions with different repetition numbers, respectively. For example, PRACH configuration index #0 is configured for PRACH transmission with repetition number=1. PRACH configuration index #4 is configured for PRACH transmission with repetition number=2. In some examples, the UE detects collision or conflict between RO windows for different PRACH transmissions with different repetition numbers (e.g., two RO windows for different PRACH transmissions with different repetition numbers overlap in time). This may be the result of PRACH resources for different PRACH transmissions with different repetition numbers being independently configured. That is, the UE may determine the same resource according to the different configurations for PRACH transmissions with different repetition numbers. In some examples, the UE uses an offset for modifying the time-domain resource (e.g., for PRACH transmissions with a larger repetition number). In some examples, the UE determines that at least two of the plurality of time-domain windows overlap in time and modifies one or more of the at least two of the plurality of time-domain windows based on at least one offset.

In some examples, the UE determines that at least two PRACH resources within each time-domain window overlap in both of time and frequency domains, and the UE modifies one or more of the at least two PRACH resources based on at least one offset. The at least one offset can be time domain offset or frequency domain offset.

FIG. 11 illustrates resources 1100 that the UE can use to transmit uplink data (e.g., PRACH-related data) according to some arrangements. The horizontal dimension corresponds to time, and the vertical dimension corresponds to frequency. Each block in FIG. 11 is one of the resources 1100, which along the horizontal dimension corresponds to a frame. In the example shown in FIG. 11, the UE may detect that the conflict occurs in a radio frame that satisfies:

$$SFN mod 16 = 1. \qquad ( 7 )$$

This frame 1110 can be used as an RO window by the UE for PRACH transmission with repetition number N=1 (no repetition). The radio frame 1120 used for PRACH transmission with repetition number N=2 can be determined by the UE by adding an offset, e.g., 1 frame. Then, the radio frame that satisfies:

$$SFN mod 16 = 2 \qquad ( 8 )$$

can be used for PRACH transmission with repetition number=2. Regarding the radio frame that does not conflict (e.g., overlap) with PRACH transmission with a different repetition number, the original configuration as received by the UE from the base station can be followed. For example, radio frame 1130 SFN=9 is determined according to configuration for PRACH transmission with repetition number=2 (e.g., SFN mod 8=1), no offset will be used for modifying it as it doesn't conflict with other PRACH transmission.

In some arrangements, different PRACH configuration tables can be defined for PRACH transmissions with different repetition numbers. The PRACH transmission resource (e.g., the RO window) can be determined according to the corresponding table. In some arrangements, if there are conflict between PRACH transmissions with different repetition numbers, the UE can apply an offset for modifying the PRACH transmission resource for at least one of the PRACH transmission.

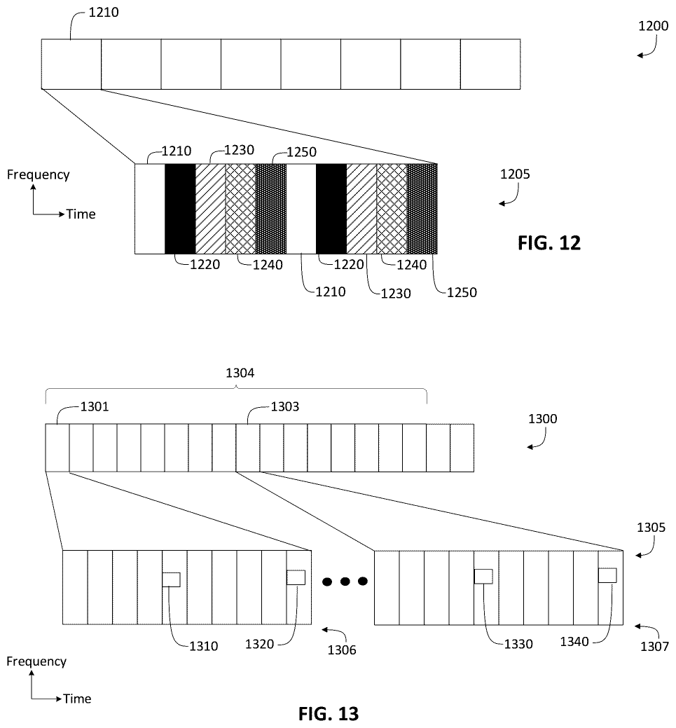

In some arrangements, a subframe-level offset instead of or in addition to the frame-level offset can be defined and used for modifying the PRACH transmission resource for at least one of PRACH transmission. FIG. 12 illustrates frames 1200 and subframes (or slots) 1205 that the UE can use to transmit uplink data (e.g., PRACH-related data) according to some arrangements. The horizontal dimension corresponds to time (e.g., the frames and the subframes), and the vertical dimension corresponds to frequency. For example, frame 1201 includes subframes (or slots) 1210-1250. In the example shown in FIG. 12, according to the configuration received by the UE from the base station, subframes (or slots) 1250 (e.g., subframes (or slots) indices 4 and 9) are the subframes (or slots) for PRACH transmission with repetition number N=1. For PRACH transmission with other repetition numbers, the UE can use a subframe-level offset for determining the transmission resource, e.g., subframes (or slots) 1240 (e.g., subframes (or slots) indices 3 and 8) are used for PRACH transmission with repetition number N=2. subframes (or slots) 1230 (e.g., subframes (or slots) indices 2 and 7) are used for PRACH transmission with repetition number N=4. Subframe 1220 (e.g., subframes (or slots) indices 1 and 6) are used for PRACH transmission with repetition number N=8.

In some arrangements, a same RACH configuration including at least one of prach-ConfigurationIndex, msg1-FDM, msg1-FrequencyStart, ra-Response Window, totalNumberOfRA-Preambles, and ssb-perRACH-OccasionAndCB-PreamblesPerSSB, etc.) is used for different RO windows for PRACH transmission with same repetition number.

In some arrangements, different RACH configurations including two or more of prach-ConfigurationIndex, msg1-FDM, msg1-FrequencyStart, ra-Response Window, totalNumberOfRA-Preambles and ssb-perRACH-OccasionAndCB-PreamblesPerSSB, etc.) are used for different RO windows for PRACH transmission with different repetition numbers.

In some examples, each of a plurality of time-domain windows correspond to one of a plurality of PRACH transmissions. Each of the plurality of PRACH transmissions has a different number of repetitions. Accordingly, the time-domain window for PRACH transmission with different repetition number can be defined and implemented efficiently. The network can effectively distinguish RACH transmission with different number of repetitions to avoid confusion and improve PRACH receiving performance.

In some arrangements, association between RO and SSB within or across different RO windows can be defined. In some examples in which one or more ROs are within a RO window according the PRACH configuration, the ROs are sorted and then mapped to one or more SSBs. A UE transmits the PRACH in a RO mapped to a selected SSB. During this procedure, the RO sorting rules based on which the ROs are sorted are considered in combination with the attributes of RO window. As discussed in further details herein, the sorting can be performed in multiple RO windows within a time period, in each RO window, or in multiple RO windows to guarantee a certain repetition number of PRACH transmission. In other words, in some examples, the UE sorts a plurality of time-domain resources in the time-domain window and maps the plurality of time-domain resources to at least one SSB based on the sorting.

In some arrangements, the UE performs cyclic association or cyclic mapping in multiple RO windows within a certain time period (for example, 160 ms). In other words, in examples, the UE maps a plurality of time-domain resources in two or more of the plurality of time-domain windows within a time period to at least one SSB. The multiple RO windows are configured for PRACH transmission with same repetition number. FIG. 13 illustrates frames 1300 and subframes (or slots) 1305 that the UE can use to transmit uplink data (e.g., PRACH-related data) according to some arrangements. The horizontal dimension corresponds to time (e.g., frames and subframes), and the vertical dimension corresponds to frequency. For example, frame 1301 includes subframes (or slots) 1306, and frame 1303 includes subframes (or slots) 1307.

As shown in FIG. 13, the period 1304 is defined as multiple frames (e.g., 16 frames (with SFN 0, SFN 1, SFN 2, . . . , SFN 15, respectively) or 160 ms). Within the period 1304, there are two RO windows (e.g., frames 1301 with SFN 0 and 1303 with SFN 8) that are configured for PRACH transmission with repetition number=1. There may be other RO windows in the period 1304 that are not shown. There are two time-domain resources for transmitting the PRACH (e.g., 2 ROs) in each RO window. For example, in the RO window 1301, there are two ROs 1310 (in subframe 4) and 1320 (in subframe 9). In the RO window 1303, there are two ROs 1330 (in subframe 4) and 1340 (in subframe 9). Thus, there are totally 4 ROs within this period 1304.

Three SSBs are transmitted in this cell, e.g., SSB #0, SSB #1 and SSB #3. One SSB is associated with one RO in this example, in an one-to-one mapping. Other mapping methods, such as multiple-to-one or one-to multiple mappings may be similarly implemented. The first RO 1310 (earliest in time) within the period 1304, which is subframe #4 in SFN 0 (e.g., frame 1301) is mapped to SSB #0. The second RO 1320 (second earliest in time) within the period 1304, which is subframe #9 in SFN 0 (e.g., frame 1301) is mapped to SSB #1. The third RO 1330 (third earliest in time) within the period 1304 which is subframe #4 in SFN 8 (e.g., frame 1303) is mapped to SSB #3. As all available SSBs are already being mapped for one time. In some examples the remaining RO 1340 (the last in time) within the period 1304 which is subframe #9 in SFN 8 (e.g., frame 1303) cannot complete a complete round of SSB-RO association. Therefore, the RO 1340 is not associated with any SSB.

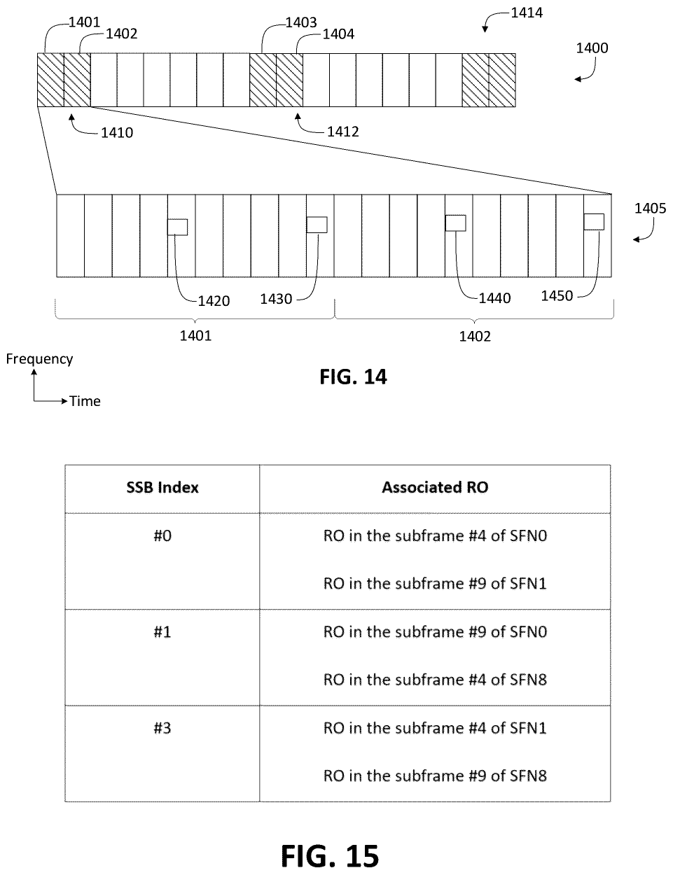

In some arrangements, the UE performs cyclic association or cyclic mapping in each RO window. In other words, in some examples, the UE maps a plurality of time-domain resources in each of the plurality of time-domain windows to at least one SSB. FIG. 14 illustrates frames 1400 and subframes (or slots) 1405 that the UE can use to transmit uplink data (e.g., PRACH-related data) according to some arrangements. The horizontal dimension corresponds to time (e.g., frames and subframes), and the vertical dimension corresponds to frequency. For example, each of the frames 1401, 1402, 1403, and 1404 includes 10 subframes (or slots) as shown.

As shown in FIG. 14, each RO window 1410, 1412, and 1414 includes two frames. For example, the RO window 1410 includes RO frames 1401 (SFN=0) and 1402 (SFN=1). The RO window 1412 includes RO frames 1403 (SFN=8) and 1404 (SFN=9). There are 4 time-domain resources for transmitting the PRACH (e.g., 4 ROs) in each RO window. For example, in the RO window 1410, there are 4 ROs 1420, 1430, 1440, and 1450. The ROs 1420 and 1430 are in the frame 1401, and the ROs 1440 and 1450 are in the frame 1402.

Three SSBs are transmitted in this cell, e.g., SSB #0, SSB #1 and SSB #3. One SSB is associated with one RO in this example, in an one-to-one mapping. Other mapping methods, such as multiple-to-one or one-to multiple mappings may be similarly implemented. The first RO 1420 (earliest in time) within the RO window 1410, which is subframe #4 in SFN 0 (e.g., frame 1401) is mapped to SSB #0. The second RO 1430 (second earliest in time) within the RO window 1410, which is subframe #9 in SFN 0 (e.g., frame 1401) is mapped to SSB #1. The third RO 1440 (third earliest in time) within the RO window 1410 which is subframe #4 in SFN 8 (e.g., frame 1402) is mapped to SSB #3. As all available SSBs are already being mapped. In some examples, the remaining RO 1450 (the last in time) within the RO window 1410 which is subframe #9 in SFN 8 (e.g., frame 1402) cannot complete a complete round of SSB-RO association. Therefore, the RO 1450 is not associated with any SSB. The same association pattern can reused for other RO windows 1412 and 1414 for PRACH transmission with the same repetition number.

In some arrangements, the UE performs cyclic association or cyclic mapping in multiple RO windows to guarantee a certain repetition number of PRACH transmission. In some examples, the UE determines two or more of the plurality of time-domain windows based on a number of the at least one repetition and maps a plurality of time-domain resources in the two or more of the plurality of time-domain windows to at least one SSB. The multiple RO windows are configured for PRACH transmission with same repetition number. Referring again to FIG. 14, each RO window 1410, 1412, and 1414 includes two continuous frames. For example, the RO window 1410 includes RO frames 1401 (SFN=0) and 1402 (SFN=1). The RO window 1412 includes RO frames 1403 (SFN=8) and 1404 (SFN=9). There are 4 time-domain resources for transmitting the PRACH (e.g., 4 ROs) in each RO window. For example, in the RO window 1410, there are 4 ROs 1420, 1430, 1440, and 1450. The ROs 1420 and 1430 are in the frame 1401, and the ROs 1440 and 1450 are in the frame 1402. The RO window 1412 may include 4 ROs in the same time-domain locations.

Three SSBs are transmitted in this cell, e.g., SSB #0, SSB #1 and SSB #3. One SSB is associated with one RO in this example, in an one-to-one mapping. Other mapping methods, such as multiple-to-one or one-to multiple mappings may be similarly implemented. To guarantee PRACH transmission with repetition number N=2, at least 6 ROs are needed so that 2 ROs become associated with each SSB. Therefore, the UE combines the RO window 1410 and the RO window 1412 into a RO window combination. The RO window combination includes 8 total ROs, which allows 6 ROs to be mapped to or associated with the SSBs with repetitions, and 2 ROs are not being mapped.

Examples of associating the ROs with SSBs using the RO window combination are shown in FIGS. 15, 16, and 17. In the table shown in FIG. 15, SSB#0 is mapped to RO in subframe 4 (1420) of SFN=0 (frame 1401) and the RO in subframe 9 (1450) of SFN=1 (frame 1402). SSB #1 is mapped to RO in subframe 9 (1430) of SFN=0 (frame 1401) and the RO in subframe 4 of SFN=8 (frame 1403). SSB #3 is mapped to RO in subframe 4 (1440) of SFN=1 (frame 1402) and the RO in subframe 9 of SFN=8 (frame 1403).

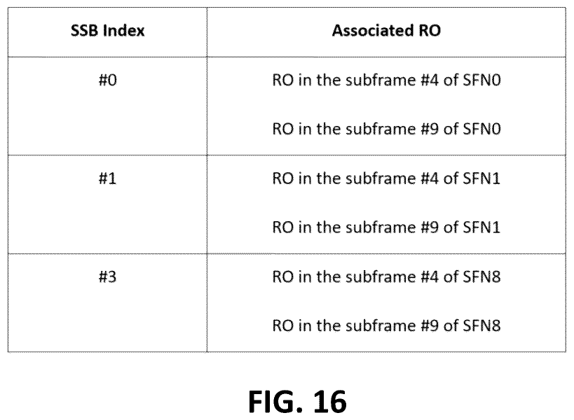

In the table shown in FIG. 16, SSB #0 is mapped to RO in subframe 4 (1420) of SFN=0 (frame 1401) and the RO in subframe 9 (1430) of SFN=0 (frame 1401). SSB #1 is mapped to RO in subframe 4 (1440) of SFN=1 (frame 1402) and the RO in subframe 9 of SFN=1 (frame 1402). SSB #3 is mapped to RO in subframe 4 of SFN=8 (frame 1403) and the RO in subframe 9 of SFN=8 (frame 1403).

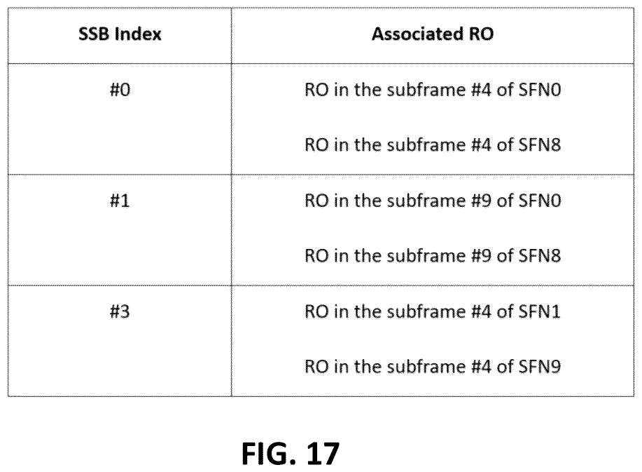

In the table shown in FIG. 17, SSB #0 is mapped to RO in subframe 4 (1420) of SFN=0 (frame 1401) and the RO in subframe 4 of SFN=8 (frame 1403). SSB #1 is mapped to RO in subframe 9 (1430) of SFN=0 (frame 1401) and the RO in subframe 9 of SFN=8 (frame 1403). SSB #3 is mapped to RO in subframe 4 (1440) of SFN=1 (frame 1402) and the RO in subframe 4 of SFN=9 (frame 1404).

The remaining ROs within the RO window combination in FIGS. 15-17 are reserved and not associated with any SSBs. Accordingly, the time-domain window for PRACH transmission with different repetition number can be defined and implemented efficiently. The network can effectively distinguish RACH transmission with different number of repetitions to avoid confusion and improve PRACH receiving performance.

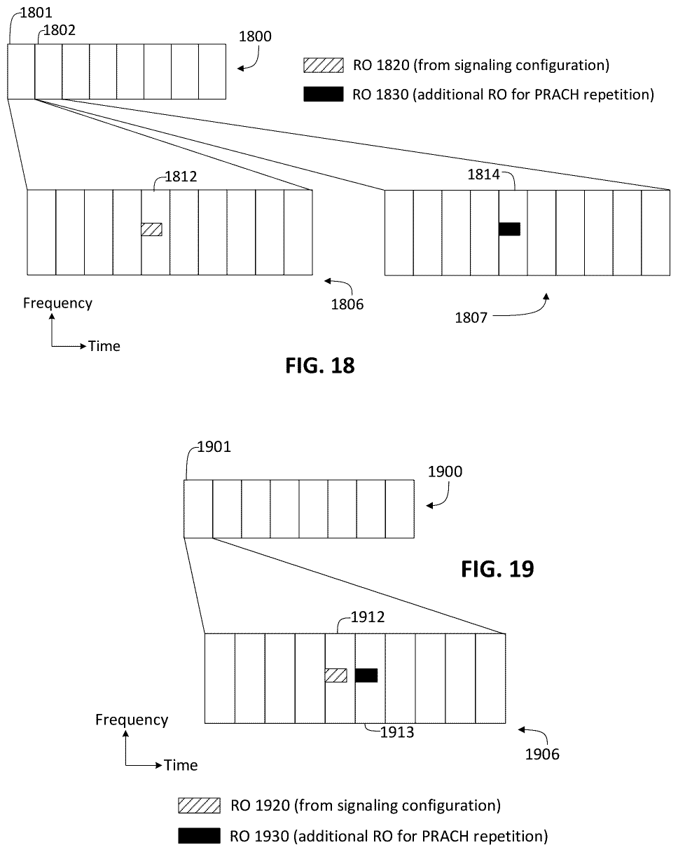

FIG. 18 illustrates radio frames 1800 and subframes (or slots) 1806 and 1807 that the UE can use to transmit uplink data (e.g., PRACH-related data) according to some arrangements. The horizontal dimension corresponds to time (e.g., radio frames and subframes), and the vertical dimension corresponds to frequency. For example, radio frame 1801 includes subframes (or slots) 1806, and frame 1802 includes subframes (or slots) 1807. In some arrangements, time-domain resources (e.g., ROs) of PRACH repetition occupy continuous radio frames, and the first M time-domain resources (e.g., RO 1820) are obtained through signaling configuration. When M is smaller than the number of repetition times N, the last (N−M) time-domain resources (additional RO such as RO 1830) occupy the radio frames adjacent to the radio frames for the first M time-domain resources. In FIG. 18, for PRACH transmission with repetition number N=2, the RO 1820 in a subframe 1812 of the first radio frame 1801 is obtained through signaling configuration, and the additional RO 1830 is determined according the rule above, i.e., it is located within the second radio frame 1802, in subframe 1814. The RO 1820 and the RO 1830 occupy the same time-domain location within each radio frame, e.g., same subframe (e.g., the sub-frames 1812 and 1814 have the same subframe index) and same symbols (e.g., RO 1820 and RO 1830 have same starting symbol index and same number of symbols).

FIG. 19 illustrates radio frames 1900 and subframes (or slots) 1906 that the UE can use to transmit uplink data (e.g., PRACH-related data) according to some arrangements. The horizontal dimension corresponds to time (e.g., radio frames and subframes), and the vertical dimension corresponds to frequency. For example, radio frame 1901 includes subframes (or slots) 1906. In some arrangements, time-domain resources (e.g., ROs) of PRACH repetition occupy continuous subframes (or slots), and the first M time-domain resources (e.g., RO 1920) are obtained through signaling configuration. When M is smaller than the number of repetition times N, the last (N−M) time-domain resources (additional RO such as RO 1930) occupy the subframes (or slots) adjacent to the subframes (or slots) for the first M time-domain resources. In FIG. 19, for PRACH transmission with repetition number N=2, a RO 1920 in the fifth subframe 1912 (or slot) of the first radio frame 1901 is obtained through signaling configuration, and an additional RO 1930 is determined according the rule above, e.g., it is located within the sixth subframe 1913 (or slot) of the first radio frame 1901. The RO 1920 and the RO 1930 occupy the same time-domain location within each sub-frame (or slot), i.e., same symbols (e.g., RO 1820 and RO 1830 have same starting symbol index and same number of symbols).

Some arrangements relate to defining different frequency domain resource for PRACH transmissions with different repetition numbers. The base station can configure frequency resource for PRACH transmission for the UE via RRC signaling, e.g., msg1-FDM and msg1-FrequencyStart. In some examples, msg1-FDM indicates the number of FDMed PRACH transmission resource, and msg1-FrequencyStart represents the frequency starting point (e.g., the frequency starting RB index) of the first PRACH transmission resource (e.g., the lowest resource). In some examples, 4 PRACH repetition numbers are supported within a cell, e.g., N=1, 2, 4, 8.

In some arrangements, the base station configures for the UE a set of frequency resource for PRACH transmission for each PRACH repetition number. A number of sets of frequency resources (equal to the repetition numbers, e.g., 4) for PRACH transmissions are configured. In some arrangements, the UE receives from the base station, a set of frequency-domain resources for each of a number of the at least one repetition.

In some arrangements, the base station configures for the UE a reference set of frequency resources for PRACH transmission for PRACH transmission with one repetition number, e.g., N=1. In addition, the base station further configures for the UE one or more frequency offsets for determining frequency resource for PRACH transmission with at least one other repetition number (e.g., N=2, 4, and 8). In some examples, the UE receives from the base station, a reference set of frequency-domain resources for one number of the at least one repetition, receives from the base station, one or more offsets corresponding to at least one other number of the at least one repetition, and determines a set of frequency-domain resources for each of the at least one other number of the at least one repetition based on the reference set of frequency-domain resources and the one or more offsets.

In some arrangements, the configuration of ‘msg1-FDM’ is shared by all PRACH transmissions with different repetition numbers. In some examples, the UE receives from the base station, a number of frequency-domain multiplexed resources which is the same for any number of the at least one repetition. For example, msg1-FDM=2 represents there are 2 frequency-domain resources for each of PRACH transmission with repetition number=1, 2, 4, 8, respectively. Accordingly, there are 8 FDMed PRACH transmission resources in total. The configuration of ‘msg1-FrequencyStart’ is valid for PRACH transmission with repetition number=1. The frequency starting point for PRACH transmission with other repetition numbers can be determined by the UE implicitly. For example, the ending RB of frequency resource for PRACH transmission with repetition number N=1 is X, and RB (X+B) is the frequency start of PRACH transmission with repetition number N=2. B is a positive integer, e.g., B=1. Similarly, assuming RB (Y) is the ending RB of frequency resource for PRACH transmission with repetition number N=2, RB (Y+1) is the frequency start of PRACH transmission with repetition number N=4, and so on. Accordingly, different frequency resources can be obtained. Accordingly, in some examples, the UE receives from the base station, a frequency starting point of a first one of a plurality of frequency-domain resources corresponding to a first number of the at least one repetition and determines a frequency starting point of a second one of the plurality of frequency-domain resources corresponding to a second number of the at least one repetition.

In some arrangements, a time-domain resource for PRACH transmissions with a greater repetition number may span more frames than a time-domain resource for PRACH transmissions with a lesser repetition number. In some examples, the time-domain resource comprises a first time-domain resource corresponding to a first number of repetitions and a second time-domain resource corresponding to a second number of repetitions. The first time-domain resource and the second time-domain resource have a same starting point. The first number is greater than the second number. The first time-domain resource spans a longer time period than the second time-domain resource.

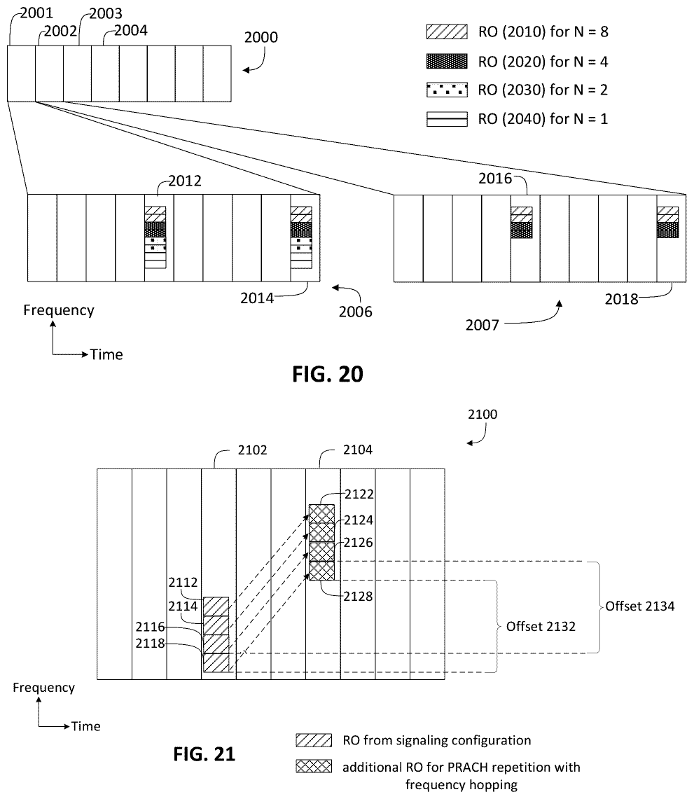

FIG. 20 illustrates frames 2000 and subframes (or slots) 2006 and 2007 that the UE can use to transmit uplink data (e.g., PRACH-related data) according to some arrangements. The horizontal dimension corresponds to time (e.g., frames and subframes), and the vertical dimension corresponds to frequency. For example, frame 2001 includes subframes (or slots) 2006, and frame 2002 includes subframes (or slots) 2007. For PRACH transmissions with different repetition numbers can be transmitted using ROs 2010, 2020, 2030, and 2040 as shown. According to the PRACH configuration, radio frame (e.g., frame 2001) that satisfies SFN mod 8=0 is determined as radio frames for PRACH transmission. There are two ROs in the time-domain in a radio frame. As shown, in the frame 2001, the ROs are located in the time-domain in subframes (or slots) 2012 and 2014. PRACH transmission with more than 2 repetitions cannot be achieved within the frame 2001 alone. For PRACH transmissions with repetition number N=4, the radio frames for PRACH transmissions can be extended from frame 2001 (SFN0) to frame 2001 and 2002 (SFN1). For PRACH transmission with repetition number N=8, the radio frames for PRACH transmission can be extended from frame 2001 (SFN0) to frames 2001, 2002, 2003, and 2004 (SFN0˜3). As shown, the UE transmits PRACH transmission for repetition numbers N=1, 2, 4, and 8 in ROs 2040, 2030, 2020, and 2010 respectively in subframes (or slots) 2012 and 2014. The UE transmits PRACH transmission for repetition numbers N=4 and 8 in ROs 2010 and 2020 in subframes (or slots) 2016 and 2018. The UE transmits PRACH transmission for repetition number N=8 in RO 2010 in subframes (or slots) of the frames 2003 and 2004.

Accordingly, the time-domain window for PRACH transmission with different repetition number can be defined and implemented efficiently. The network can effectively distinguish RACH transmission with different number of repetitions to avoid confusion and improve PRACH receiving performance.

In some arrangements, the frequency-domain resource for PRACH transmission within a PRACH repetition bundle can be different. The frequency-domain resource can also be referred to as PRACH transmission with frequency hopping. For example, for PRACH transmission with repetition number N=4, there are four times of PRACH transmission within the PRACH repetition bundle.

In some arrangements, the frequency-domain resource includes at least one configured frequency-domain resource and at least one additional frequency-domain resource mapped to the at least one configured frequency-domain resource. The at least one configured frequency-domain resource and the at least one additional frequency-domain resource are non-overlap in a frequency domain. FIG. 21 illustrates subframes (or slots) 2100 that the UE can use to transmit uplink data (e.g., PRACH-related data) according to some arrangements. The subframes (or slots) include subframes (or slots) 2102 and 2104. The horizontal dimension corresponds to time (e.g., frames, subframes, or slots), and the vertical dimension corresponds to frequency. ROs 2112, 2114, 2116, and 2118 are in subframes (or slots) 2102, and ROs 2122, 2124, 2126, and 2128 are in subframes (or slots) 2104. As an example shown in FIG. 21, each of the ROs 2112, 2114, 2116, and 2118 configured via signaling is mapping with an additional RO 2122, 2124, 2126, and 2128 respectively. For example, RO 2112 is mapped to 2122, RO 2114 is mapped to 2124, RO 2116 is mapped to 2126, and RO 2118 is mapped to 2128. The additional ROs 2122, 2124, 2126, and 2128 are located on one side of the configured ROs from frequency domain. For example, the additional ROs 2122, 2124, 2126, and 2128 are all located at the higher-frequency side of the configured ROs 2112, 2114, 2116, and 2118 as shown. In some arrangements, the additional ROs are all located at the lower-frequency side of the configured ROs. A signaling can be used to indicate which side of the bandwidth of the configured ROs that is currently used by the additional ROs 2122, 2124, 2126, and 2128, i.e., lower or higher in frequency than the configured ROs 2112, 2114, 2116, and 2118. The configured ROs 2112, 2114, 2116, and 2118 and the additional ROs 2122, 2124, 2126, and 2128 are combined to provide transmission resources for PRACH repetition with frequency hopping. Each of configured ROs and one of the additional ROs 2122, 2124, 2126, and 2128 corresponding with it can be called as a RO combination. The frequency-domain offset (e.g., 2132, 2134) between the configured ROs 2112, 2114, 2116, and 2118 and corresponding additional ROs 2122, 2124, 2126, and 2128 for different RO combinations can be same, i.e., offset 2132 (between RO 2118 and RO 2128) equals to offset 2134 (between RO 2116 and RO 2126) in FIG. 21. In some examples, the offset is indicated via signaling, e.g., RRC signaling, MAC layer signaling or physical layer signaling, etc. In some examples, an additional frequency-domain starting RB for the first additional RO can be configured, e.g., the first RB of RO 2128 in FIG. 21. In some examples, the starting RB of the first additional RO can be determining according to the configuration of configured RO, e.g., the starting RB of the first additional RO is the last RB of the last configured RO plus a margin (e.g., one), or the last RB of the last additional RO is the first RB of the first configured RO minus a margin (e.g., one). The additional ROs are connected to each other in the frequency domain.

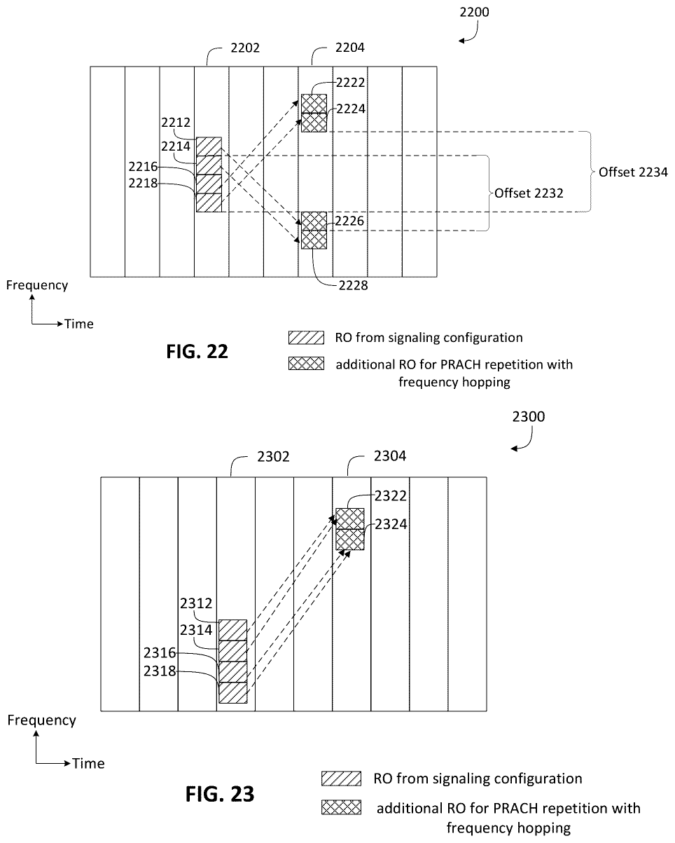

FIG. 22 illustrates subframes (or slots) 2200 that the UE can use to transmit uplink data (e.g., PRACH-related data) according to some arrangements. The subframes (or slots) include subframes (or slots) 2202 and 2204. The horizontal dimension corresponds to time (e.g., frames, subframes, or slots), and the vertical dimension corresponds to frequency. ROs 2212, 2214, 2216, and 2218 are in subframes (or slots) 2202, and ROs 2222, 2224, 2226, and 2228 are in subframes (or slots) 2204. As shown in FIG. 22, each of the RO 2212, 2214, 2216, and 2218 configured via signaling is mapping with one of additional ROs 2222, 2224, 2226, and 2228. For example, RO 2212 is mapped to 2222, RO 2214 is mapped to 2224, RO 2216 is mapped to 2226, and RO 2218 is mapped to 2228. The additional ROs 2222, 2224, 2226, and 2228 are located at both sides of the configured ROs 2212, 2214, 2216, and 2218 in the frequency domain. In FIG. 22, there are additional ROs (e.g., RO 2222 and RO 2224) located at higher-frequency side of the configured ROs 2212, 2214, 2216, and 2218, and another two additional ROs (e.g., RO 2226 and RO 2228) are located at lower-frequency side of the configured ROs 2212, 2214, 2216, and 2218. The configured ROs 2212, 2214, 2216, and 2218 and the additional ROs 2222, 2224, 2226, and 2228 are combined to provide transmission resources for PRACH repetition with frequency hopping. Each of the configured ROs 2212, 2214, 2216, and 2218 and one of the additional ROs 2212, 2214, 2216, and 2218 corresponding thereto can be referred to as a RO combination. The absolute values of the frequency offsets (e.g., offsets 2232 and 2234) between the configured ROs 2212, 2214, 2216, and 2218 and corresponding additional ROs 2212, 2214, 2216, and 2218 for different RO combinations can be same. That is, the absolute value of offset 2234 (between RO 2218 and RO 2224) equals to offset 2232 (between RO 2212 and RO 2226). In some examples, the offset is indicated via signaling, e.g., RRC signaling, MAC layer signaling or physical layer signaling, etc. The offset can be configured for all the RO combinations or can be configured for each RO combination, respectively. In some examples, an additional signaling can used for indicating the frequency starting RB for each side of the additional ROs 2212, 2214, 2216, and 2218, in some examples. In some examples, the configured ROs 2212, 2214, 2216, and 2218 and additional ROs 2212, 2214, 2216, and 2218 are connected to each other in the frequency domain. That is, the starting RB of the first additional RO (e.g., 2224) in the higher frequency is the last RB of the last configured RO (e.g., 2212) plus a margin (e.g., one), and the last RB of the last additional RO (e.g., 2226) in lower frequency is the first RB of the first configured RO (e.g., 2218) minus a margin (e.g., one).

FIG. 23 illustrates subframes (or slots) 2300 that the UE can use to transmit uplink data (e.g., PRACH-related data) according to some arrangements. The subframes (or slots) include subframes (or slots) 2302 and 2304. The horizontal dimension corresponds to time (e.g., frames, subframes, or slots), and the vertical dimension corresponds to frequency. ROs 2312, 2314, 2316, and 2318 are in subframes (or slots) 2302, and ROs 2322, 2324 are in subframes (or slots) 2304. As another example shown in FIG. 23, two or more of the ROs 2312, 2314, 2316, and 2318 configured via signaling can be mapping with one additional RO (e.g., 2322 or 2324). The additional ROs 2322 and 2324 can be located at one side or both sides of the configured ROs 2312, 2314, 2316, and 2318 in the frequency domain. In FIG. 23, two configured ROs are mapped with one additional RO. For example, e.g., RO 2318 and RO 2316 are mapped with RO 2324, RO 2314 and RO 2312 are mapped with RO 2322. The mapping relationship between a configured RO and an additional RO can be configured via RRC signaling. For example, a mapping factor can be configured as 2, meaning that two configured ROs are mapped to an additional RO. The configured ROs mapping with the same additional RO can be adjacent (e.g., adjacent configured ROs in the frequency domain are mapped to a same additional RO) or not adjacent (e.g., at least two non-adjacent configured ROs with an RO in between in the frequency domain are mapped to a same additional RO). In some examples, an additional signaling can used for indicating the frequency starting RB for the additional RO on each side of the configured ROs in the frequency domain, in some examples. In other examples, the configured ROs and additional ROs are connected to each other (e.g., continuous with no gap in between) in the frequency domain. That is, the starting RB of the first additional RO in the higher frequency is the last RB of the last configured RO plus a margin (e.g., one), and the last RB of the last additional RO in lower frequency is the first RB of the first configured RO minus a margin (e.g., one).

In some arrangements, the time-domain window can be determined according to an SSB index or a sequence of SSBs among all of the actual transmission SSBs. With regard to a sequence of SSBs among all of the actual transmission SSBs, if three SSBs (e.g., #0, #2, #4) are actual transmitted, the sequence of SSB #0 among all of the actual transmission SSBs is 1, the sequence of SSB #2 among all of the actual transmission SSBs is 2, and sequence of SSB #4 among all of the actual transmission SSBs is 3. In other words, the sequence refers to the sequential position or sequence number in time in which an SSB is transmitted.

In some examples, the RO window can be determined in the manner described herein except that the role of the repetition number is replaced by the SSB index or the sequence of

SSBs among all of the actual transmission SSBs. Then, each RO window is associate with a same SSB, and PRACH repetition with different beams can be transmitted within the RO window. Therefore, in some examples, the time-domain window is determined according to SSB index or SSB sequence.

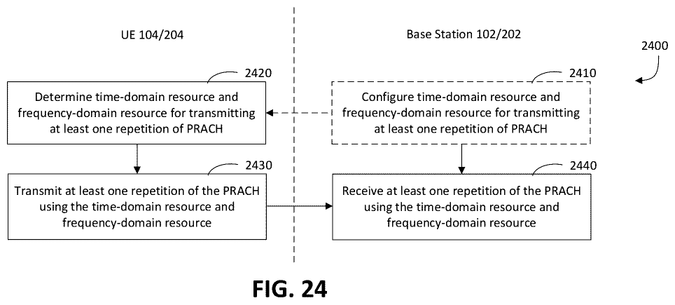

FIG. 24 is a flowchart diagram illustrating an example method 2400 for transmitting at least one repetition of PRACH, according to some arrangements. Referring to FIGS. 1-24, the method 2400 can be performed by the UE 104/204 and the base station 102/202.

At 2420, the UE determines a time-domain resource and a frequency-domain resource for transmitting at least one repetition of a PRACH. In some examples, determining the time-domain resource and the frequency-domain resource includes receiving the configurations, indications, or other information defining the time-domain resource and the frequency-domain resource from the network. In that regard, at 2410, the base station may configure the time-domain resource and the frequency-domain resource for transmitting at least one repetition of a PRACH. In other examples, the UE can determine the time-domain resource and the frequency-domain resource using other methods.

At 2430, the UE transmits to the base station the at least one repetition of the PRACH using the time-domain resource and the frequency-domain resource. At 2440, the base station receives from the UE the at least one repetition of the PRACH using the time-domain resource and the frequency-domain resource.

In some examples, the UE determines a time-domain window (e.g., an RO window). The time-domain resource is within the time-domain window. In some examples, each of a plurality of time-domain windows correspond to one of a plurality of PRACH transmissions. Each of the plurality of PRACH transmissions has a different number of repetitions.

In some examples, the plurality of time-domain windows are arranged according to an order, or the plurality of time-domain windows are cyclical. The order in which the plurality of time-domain windows are arranged comprises an ascending order of the numbers of repetitions of each of the plurality of PRACH transmissions. In some examples, the plurality of time-domain windows are consecutively connected to one another. In some examples, the plurality of time-domain windows comprises at least one time-domain window group, the at least one time-domain window group appears periodically, and adjacent time-domain window groups are discontinuous. In some examples, the plurality of time-domain windows comprises at least two sets of time-domain window group, the time-domain window groups in one set appear periodically, and different time-domain window group sets are configured with different periods. In some examples, the UE determines a length for each of the plurality of time-domain windows. Lengths of two or more of the plurality of time-domain windows are same or different. The UE determines the length for each of the plurality of time-domain windows by receiving, by the UE from the base station, a reference length and at least one scaling factor, and determining, by the UE, the length for each of the plurality of time-domain windows based on one or more of the reference length, the at least one scaling factor, and the different number of repetitions.

In some examples, the UE determining the plurality of time-domain windows by determining a reference time-domain window (e.g., corresponding to no repetition) and determining at least one time-domain window (e.g., corresponding to at least one repetition or two transmissions) based on the reference time-domain window and an offset. In some examples, the reference time-domain window corresponds no repetition of the PRACH. Each of the at least one time-domain window corresponds to at least one repetition of the PRACH. The offset is determined based on a step size and a repetition number of the at least one repetition. In some examples, the UE determines that two of the plurality of time-domain windows overlap in time and modifies one of the two of the plurality of time-domain windows based on an offset.

In some examples, the UE sorts a plurality of time-domain resources in the time-domain window and maps the plurality of time-domain resources to at least one SSB based on the sorting. In some examples, the UE maps a plurality of time-domain resources in two or more of the plurality of time-domain windows within a time period to at least one SSB. In some examples, the UE maps a plurality of time-domain resources in each of the plurality of time-domain windows to at least one SSB. In some examples, the UE determines two or more of the plurality of time-domain windows based on a number of the at least one repetition and maps a plurality of time-domain resources in the two or more of the plurality of time-domain windows to at least one SSB.

In some arrangements, the UE receives from the base station, a set of frequency-domain resources for each of a number of the at least one repetition. In some examples, the UE receives from the base station, a reference set of frequency-domain resources for one number of the at least one repetition, receives from the base station, one or more offsets corresponding to at least one other number of the at least one repetition, and determines a set of frequency-domain resources for each of the at least one other number of the at least one repetition based on the reference set of frequency-domain resources and the one or more offsets. In some examples, the UE receives from the base station, a number of frequency-domain multiplexed resources which is the same for any number of the at least one repetition. In some examples, the UE receives from the base station, a frequency starting point of a first one of a plurality of frequency-domain resources corresponding to a first number of the at least one repetition and determines a frequency starting point of a second one of the plurality of frequency-domain resources corresponding to a second number of the at least one repetition.

In some examples, the time-domain resource comprises a first time-domain resource corresponding to a first number of repetitions and a second time-domain resource corresponding to a second number of repetitions. The first time-domain resource and the second time-domain resource have a same starting point. The first number is greater than the second number. The first time-domain resource spans a longer time period than the second time-domain resource.

In some examples, the time-domain window is determined according to SSB index or SSB sequence.

While various arrangements of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one arrangement can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed:

1. A wireless communication method, comprising:
determining, by a wireless communication device, a time-domain resource and a frequency-domain resource for transmitting at least one repetition of a Physical Random Access Channel (PRACH); and
transmitting, by the wireless communication device to the base station, the at least one repetition of the PRACH using the time-domain resource and the frequency-domain resource.

2. The wireless communication method of claim 1, further comprising determining, by the wireless communication device, a time-domain window, wherein the time-domain resource is in the time-domain window.

3. The wireless communication method of claim 1, wherein each of a plurality of time-domain windows correspond to one of a plurality of PRACH transmissions, each of the plurality of PRACH transmissions has a different number of repetitions.

4. The wireless communication method of claim 3, wherein one of:
the plurality of time-domain windows are arranged according to an order; or
the plurality of time-domain windows are cyclical.

5. The wireless communication method of claim 4, wherein the order in which the plurality of time-domain windows are arranged comprises an ascending order of the numbers of repetitions of each of the plurality of PRACH transmissions.

6. The wireless communication method of claim 3, wherein the plurality of time-domain windows are consecutively connected to one another.

7. The wireless communication method of claim 3, wherein the plurality of time-domain windows comprises at least one time-domain window group, the at least one time-domain window group appears periodically, and adjacent time-domain window groups are discontinuous.

8. The wireless communication method of claim 3, wherein the plurality of time-domain windows comprises at least two sets of time-domain window group, the time-domain window groups in one set appears periodically, and different time-domain window group sets are configured with different periods.

9. The wireless communication method of claim 3, further comprising determining a length for each of the plurality of time-domain windows, wherein lengths of two or more of the plurality of time-domain windows are same or different.

10. The wireless communication method of claim 9, further comprising determining the length for each of the plurality of time-domain windows by:
receiving, by the wireless communication device from the base station, a reference length and at least one scaling factor; and
determining, by the wireless communication device, the length for each of the plurality of time-domain windows based on at least one of the reference length, the at least one scaling factor, or the different number of repetitions.

11. The wireless communication method of claim 3, further comprising determining the plurality of time-domain windows by:
determining a reference time-domain window; and
determining at least one time-domain window based on the reference time-domain window and an offset.

12. The wireless communication method of claim 11, wherein
the reference time-domain window corresponds to no repetition of the PRACH; and
each of the at least one time-domain window corresponds to at least one repetition of the PRACH.

13. The wireless communication method of claim 11, wherein the offset is determined based on a step size and a repetition number of the at least one repetition.

14. The wireless communication method of claim 3, further comprising:
determining, by the wireless communication device, that two of the plurality of time-domain windows overlap in time; and
modifying one of the two of the plurality of time-domain windows based on an offset.

15. The wireless communication method of claim 2, further comprising:
sorting, by the wireless communication device, a plurality of time-domain resources in the time-domain window; and
mapping, by the wireless communication device, the plurality of time-domain resources to at least one Synchronization Signal/Physical Broadcasting Channel (PBCH) Block (SSB) based on the sorting.

16. The wireless communication method of claim 3, further comprising mapping, by the wireless communication device, a plurality of time-domain resources in two or more of the plurality of time-domain windows within a time period to at least one Synchronization Signal/Physical Broadcasting Channel (PBCH) Block (SSB).

17. The wireless communication method of claim 3, further comprising mapping, by the wireless communication device, a plurality of time-domain resources in each of the plurality of time-domain windows to at least one Synchronization Signal/Physical Broadcasting Channel (PBCH) Block (SSB).

18. A wireless communication device, comprising:
at least one processor configured to:
determine a time-domain resource and a frequency-domain resource for transmitting at least one repetition of a Physical Random Access Channel (PRACH); and
transmit, via a transmitter to the base station, the at least one repetition of the PRACH using the time-domain resource and the frequency-domain resource.

19. A wireless communication method, comprising:
configuring, by a base station for a wireless communication device, a time-domain resource and a frequency-domain resource for transmitting at least one repetition of a Physical Random Access Channel (PRACH); and
receiving, by the base station from the wireless communication device, the at least one repetition of the PRACH using the time-domain resource and the frequency-domain resource.

20. A base station, comprising:
at least one processor configured to:
configure, for a wireless communication device, a time-domain resource and a frequency-domain resource for transmitting at least one repetition of a Physical Random Access Channel (PRACH); and
receive, via a receiver from the wireless communication device, the at least one repetition of the PRACH using the time-domain resource and the frequency-domain resource.
